(19) United States
(12) Patent Application Publication
(10) Pub. No.: US 2007/0050287 A1
(43) Pub. Date: Mar. 1, 2007

(54) Method for structuring a new loan

(76) Inventor: Dennis R. Capozza, Ann Arbor, MI (US)

Correspondence Address: SCHOX PLC, 209 N. MAIN STREET #200, ANN ARBOR, MI, 48104, US

(21) Appl. No.: 11/213,564

(22) Filed: Aug. 26, 2005

(51) Int. Cl. G06Q 40/00

(52) U.S. Cl. 705/38

(57) ABSTRACT

The preferred method for structuring a new loan includes receiving borrower information related to the new loan; receiving performance information related to funded loans; and determining a new loan risk for the new loan based on the borrower information and the performance information.

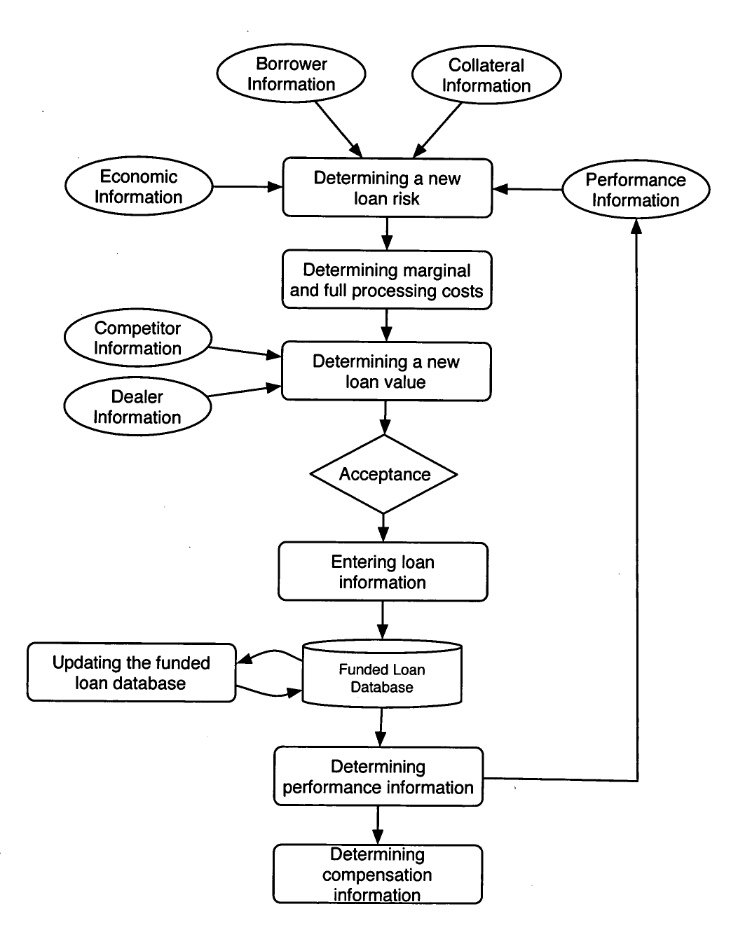

### TECHNICAL FIELD

This invention relates generally to the financial services field, and more specifically to a new and useful method for structuring new loans.

### BACKGROUND

The traditional loan processing system includes several disconnected groups or modules, including: Pricing Strategy, Marketing Strategy, Underwriting and Selection Criteria, and Product Design. The disconnection between these groups has led to several inefficiencies in lending practices, including: volume based incentives instead of profit based incentives, loan value based on national economics rather than local economics, unpredictable loan losses, and high look-to-book ratios. Thus, there is a need in the financial services field to create a new and useful method for structuring new loans that harnesses the synergy between these typically disconnected groups and modules. This invention provides such method.

### BRIEF DESCRIPTION OF THE FIGURE

The FIGURE is a flowchart of the method of the preferred embodiments.

### DESCRIPTION OF THE PREFERRED EMBODIMENTS

The following description of the preferred embodiments of the invention is not intended to limit the invention to these preferred embodiments, but rather to enable any person skilled in the art of financial services to make and use this invention.

As shown in the FIGURE, the preferred embodiments of the invention include a method for structuring a new loan. The method includes receiving borrower information related to the new loan; receiving performance information related to funded loans; and determining a new loan risk for the new loan based on the borrower information and the performance information. Although the method is preferably utilized by a lender during the structuring of a new loan for a house or a motor vehicle, the method may alternatively be used by any appropriate entity to structure any suitable debt, such as other loans, bonds, promissory notes, debentures, credit card debts, or lines of credit. Preferably, the steps of receiving borrower information, receiving performance information, and determining a new loan risk for the new loan are conducted over a computer network and completed within a single session. Alternatively, these steps may be conducted and completed with any suitable device or system and in any suitable manner.

The step of receiving borrower information functions to relate the new loan risk and other aspects of the new loan to an individual borrower, a corporate borrower, or a borrower type with very specific attributes. The borrower information preferably includes a credit score, which is a numerical value that represents an estimate of the creditworthiness of the borrower. Credit scores are typically based on factors such as the punctuality of past payments, the ratio of current revolving debt to total available revolving credit, and the length of credit history. The credit score is preferably a FICO score (developed by the Fair Isaac Corporation), but may alternatively include a Beacon score, an Emperica score, or any other appropriate credit score. In addition to the credit score, the borrower information preferably includes the contact information of the borrower and any other suitable information. The borrower information is preferably received through an electronic connection over a computer network, but may be alternatively received in any suitable manner.

In the preferred embodiments, the method also includes the step of receiving collateral information. In one variation, the new loan is a mortgage for a house and the collateral information includes the location and other suitable information about the house. In another variation, the new loan is a loan for a motor vehicle and the collateral information includes the Vehicle Identification Number (VIN) used to uniquely identify the motor vehicle. In further variations, the collateral information can be any suitable information about the assets that secure the new loan.

The step of receiving performance information functions to relate the new loan risk to the performance of funded loans. The term ‘funded loans’ refers to the collection of loans that have been accepted by a borrower and are funded by the lender. The performance information is preferably received through an electronic connection over a computer network, but may be alternatively received in any suitable manner.

In the preferred embodiments, the method also includes determining performance information related to the funded loans. The performance information is preferably based upon the loan information and service information of the funded loans. The loan information preferably includes specific attributes of the funded loans, such as the loan amount, the interest rate, and the payback periods. The service information preferably includes specific attributes of the service of the funded loans, such as delinquencies, defaults and prepayments. The performance information may, however, be based on other suitable information about the performance of the funded loans.

In the preferred embodiment, the method also includes maintaining a funded loan database relating to the funded loans. The funded loan database preferably resides on a dedicated server attached to a computer network, but may reside across a distributed network or any other suitable location. Preferably, the funded loan database includes the loan information and the service information for one or more funded loans. Alternatively, the funded loan database may include other information related to the funded loans. The funded loan database is preferably updated upon the initial funding of a new loan (e.g., upon the receipt of a borrower acceptance for a new loan). This update to the funded loan database preferably includes the borrower information related to the new loan, but may include any suitable information. Further, the funded loan database is preferably updated upon the occurrence of a service event (e.g., any of the repayment dates during the time period of the loan). This update to the funded loan database preferably includes a flag or other data piece that relates to the repayment dates, but may include any suitable information.

The step of determining a new loan risk for the new loan functions to help reduce the overall risk and/or increase the overall value of the portfolio of the funded loans of the lender. The new loan risk is preferably based on the borrower information, the performance information, and capital market information. More specifically, the new loan risk is preferably based on the probabilities of default and prepay by the borrower and the change in the value or risk of the portfolio of funded loans by the new loan. The new loan risk may, however, be based on any suitable parameter to help reduce the overall risk and/or increase the overall value of the portfolio of funded loans.

In the preferred embodiment, the method also includes determining a new loan value for the new loan based on the new loan risk. The new loan value preferably includes loan parameters (such as the interest rate and the loan term), expected performance, the risk, and the processing costs., but may alternatively include other suitable aspects. In a first variation, the method also includes determining marginal processing costs and the full processing costs related to a typical new loan. The marginal processing costs and the full processing costs are preferably determined based on previously funded loans, but may alternatively be based on empirical data from other lenders or based on estimates. The typical new loan used in the determination may be based on the entire portfolio of funded loans or may be based on a portion of the portfolio (e.g., similarly structured funded loans). With this variation, the new loan value preferably includes a minimal interest rate based on the marginal processing costs and a target interest rate based on the full processing costs. In a second variation, the method also includes receiving dealer information from a dealer of the new loan, and determining the new loan value based on the dealer information. The dealer information preferably includes loan parameters that are assigned by the dealer, such as an interest rate that is pre-determined by the dealer. With this variation, the new loan value preferably includes a dealer buy-rate or other signal to the dealer.

In a variation of the preferred embodiment, the method also includes determining compensation information for an individual employee or agent based on the performance information of one or more funded loans. The compensation information is preferably used to generate a commission or bonus for the work of an individual employee or agent of the lender, but may alternatively be used in any suitable manner. In a first variation, the compensation information is based on a subset of the funded loans that are associated with the individual employee (based on either service contribution, location, or other suitable factors). In a second variation, the compensation information is based on the entire portfolio of funded loans.

In a variation of the preferred embodiment, the method also includes receiving economic information. In this variation, the step of determining the new loan risk is further based on the economic information. The economic information preferably corresponding to a local region, such as a state, a metropolitan area, or a postal code. The economic information preferably includes local incomes, inflation rates, unemployment rates, and collateral prices, but may alternatively include other information relating to the ability of potential borrowers to default and/or prepay on their loans. The economic information is preferably updated on a quarterly basis, but may alternatively be updated on a monthly basis or on any other suitable time period.

In a variation of the preferred embodiment, the method also includes receiving competitor information. The competitor information preferably includes information related to the competitors of the lender, such as the other lenders that are located in the same local region (such as a metropolitan area or postal code) or that advertise through similar channels (such as advertisements on the Internet). The competitor information is also preferably related to similar loans (such as loan-types, borrower-types, or loan-size). The competitor information may alternatively include any suitable information that aids in the competitiveness of the new loan value. In this variation, the step of determining the new loan pricing and value is further based on the competitor information. As an example, if Lender A receives the information (through either advertised or accepted offers) that Lender B offers new loans for a particular interest rate and a particular loan term, then the new loan value may be adjusted to allow Lender A to be more competitive with Lender B from the vantage of a hypothetical prospective borrower.

As a person skilled in the art of financial services will recognize from the previous detailed description and from the figure and claims, modifications and changes can be made to the preferred embodiments of the invention without departing from the scope of this invention defined in the following claims.

I claim:

1. A method for structuring a new loan, comprising:
receiving borrower information related to the new loan;
receiving performance information related to funded loans; and
determining a new loan risk for the new loan based on the borrower information and the performance information.

2. The method of claim 1, wherein the borrower information includes a credit score.

3. The method of claim 1, further comprising receiving collateral information, wherein the step of determining the new loan risk is further based on the collateral information.

4. The method of claim 1, further comprising:
maintaining a funded loan database relating to the funded loans; and
determining performance information related to the funded loans.

5. The method of claim 4, wherein the funded loan database includes loan information for one or more funded loans, and wherein the step of determining performance information is based on the loan information.

6. The method of claim 5, further comprising updating the funded loan database to include a new funded loan, and entering the loan information for the new funded loan, wherein the loan information includes the borrower information.

7. The method of claim 6, wherein the funded loan database further includes servicing information for one or more funded loans, and wherein the step of determining performance information is further based on the service information.

8. The method of claim 7, further comprising updating the servicing information for one or more funded loans based on service events.

9. The method of claim 8, further comprising determining compensation information for an individual employee based on the performance information of one or more funded loans.

10. The method of claim 1, wherein the new loan risk includes default and prepay probabilities.

11. The method of claim 1, further comprising receiving economic information corresponding to a local region, wherein the step of determining the new loan risk is further based on the economic information.

12. The method of claim 1, further comprising determining a new loan value for the new loan based on the new loan risk.

13. The method of claim 12, wherein the new loan value includes an interest rate for the new loan.

14. The method of claim 12, further comprising receiving dealer information, and wherein the step of determining a new loan value is also based on the dealer information.

15. The method of claim 14, wherein the new loan value includes a dealer buy-rate.

16. The method of claim 12, further comprising determining marginal processing costs related to a typical new loan, and wherein the new loan value includes a minimal interest rate based on the marginal processing costs.

17. The method of claim 16, further comprising determining full processing costs related to a typical new loan, and wherein the new loan value includes a target interest rate based on the full processing costs.

18. The method of claim 1, further comprising receiving competitor information; wherein the step of determining the new loan value is further based on the competitor information.

19. The method of claim 1, wherein the steps of receiving borrower information, receiving performance information, and determining a new loan risk for the new loan are conducted over a computer network and completed within a single session.

20. A method for using and updating a funded loan database, comprising:
receiving borrower information related to a new loan;
maintaining a funded loan database relating to the funded loans; wherein the funded loan database includes loan information for one or more funded loans;
determining performance information related to the funded loans based on the loan information;
determining a new loan value for the new loan based on the new loan risk based on the borrower information and the performance information; and
upon receiving borrower acceptance of the new loan, updating the funded loan database to include the new loan.
